(19) United States
(12) Patent Application Publication
(10) Pub. No.: US 2026/0184006 A1
(43) Pub. Date: Jul. 2, 2026

(54) CONTAINER TREATMENT LINE AND CONTAINER TREATMENT METHOD FOR TREATING CONTAINERS IN A CONTAINER TREATMENT LINE

(71) Applicant: Krones AG, Neutraubling (DE)

(72) Inventors: Andreas Meyer, Neutraubling (DE); Benedikt Boettcher, Neutraubling (DE); Robert Aust, Neutraubling (DE); Konrad Senn, Neutraubling (DE); Markus Stubenhofer, Neutraubling (DE); Daniel Peter, Neutraubling (DE)

(21) Appl. No.: 19/416,024

(22) Filed: Dec. 11, 2025

(30) Foreign Application Priority Data
Dec. 30, 2024 (DE) 102024139924.4

(51) Int. Cl. B29C 49/80

(52) U.S. Cl. CPC B29C 49/80

(57) ABSTRACT

A container treatment line and a container treatment method for treating containers in a container treatment line are provided. The container treatment line has at least two container treatment devices that comprise at least one first container treatment device for treating the containers and a second container treatment device for treating the containers, and which are configured to exchange data with one another in relation to the treatment of the containers, at least one determination device for determining an actual state of at least one predetermined element that is intended for treating the containers with at least one of the at least two container treatment devices, a comparison device for comparing the actual state determined by the determination device with a predetermined state stored in a first database, which is a measurement and/or control state in relation to the operation of an external container treatment line, which comprises at least one container treatment device that is at least partially structurally identical to one of the at least two container treatment devices, and a coordination device for coordinating at least one setting for treating the containers to be made in the first container treatment device with at least one setting for treating the containers to be made with the second container treatment device, wherein the coordination device is configured to carry out its coordination on the basis of the comparison result of the comparison device.

### CROSS REFERENCE TO RELATED APPLICATIONS

This application claims priority to German Patent Application No. 102024139924.4 filed on Dec. 30, 2024, the entirety of which is incorporated by reference.

### DESCRIPTION

The invention relates to a container treatment line and a container treatment method for treating containers in a container treatment line.

Containers for holding foodstuff or beverages, cleaning agents or cosmetics include, for example, glass containers, containers made of pulp, or plastics containers. The containers are configured in particular as bottles or cans.

Glass containers are typically filled with a filling product—in particular a foodstuff or beverage as noted above—in a container treatment line and then delivered ready for sale.

The starting material for containers made from pulp is a fiber-based material that can be biodegradable. The pulp is a mixture of fibrous material and liquid, which can contain fibers and/or larger particles. The pulp usually has a mushy consistency. For example, papier-mâché is a pulp. In order to manufacture containers, water is removed from the pulp in the container treatment line.

Plastics containers are manufactured from plastics preforms using a container treatment line. A container treatment line for this purpose comprises a heating device and, for example, a blow-molding machine. After heating in the heating device, the preforms are placed in a blow mold of the blow-molding machine by blowing in a gaseous medium into the shape of the desired finished container. In stretch-blow-molding machines, the containers are also stretched using a stretching bar. Depending on the circumstances, the container treatment line also comprises a manufacturing device for preforms, in particular an injection molding machine or a compression molding machine for manufacturing the preforms.

Regardless of the container material, at least one transport device for transporting the containers is provided in the container treatment line. In particular, in a line for plastics containers, a transport device is present in the heating device, to the blow-molding machine, and from the blow-molding machine to at least one downstream container treatment device.

The at least one downstream container treatment device can, regardless of the container material, be or comprise at least one of the following container treatment devices: a transport device, an inspection device for inspecting the preforms or the containers, a decorating device for decorating the containers with at least one label and/or printing, a filling device or filling machine for filling the containers with a filling product, in particular a liquid or free-flowing foodstuff, etc., a cleaning device, a packaging device, or any other container treatment device.

EP 0 352 633 B1 discloses a method for blow molding containers, in which, following blow molding of a container, an actual value of a wall thickness is measured at at least one height level of the container and a control system specifies a value of at least one parameter influencing the blowing process as a function of a difference between a target value and the measured actual value for the wall thickness.

WO 2022/238032 A1 discloses a labeling machine and a method for configuring a labeling machine, in which configuration parameters are created by an artificial-intelligence module. The created configuration parameters are used to configure a plurality of modules of the labeling machine. The plurality of modules is used at least for labeling and/or printing on containers.

For the smooth execution of the treatment(s) of the containers in the successive container treatment devices of the container treatment line, a plurality of settings are to be made in order to ensure flawlessly manufactured/filled/packaged containers without undesired downtimes of the container treatment line. The coordination of settings is essential, such as the setting of a component of the line and/or the setting of a treatment medium. The setting of a component is, for example, the height and/or temperature and/or radiation direction of a heating emitter and/or the transport speed of a starwheel in a transport device, etc. The setting of a treatment medium is, for example, the temperature and/or composition of a treatment medium, such as a cleaning fluid, a cooling fluid, or other media. Since the container treatment line can have a throughput of approximately 40,000 containers per hour or more, the settings of the line usually need to be highly precise to ensure smooth operation. As a result, the process of making the settings is highly time-consuming and, furthermore, often has to be continuously monitored during operation and readjusted as required in relation to the particular prevailing operating conditions.

Therefore, the object of the present invention is to provide a container treatment line and a container treatment method for treating containers in a container treatment line, which solve the aforementioned problems. In particular, a container treatment line and a container treatment method for treating containers in a container treatment line is to be provided, which can manufacture high-quality containers in a cost-effective manner in relation to time, manufacturing costs and operating costs, so that the reject rate is low.

The aforementioned object is achieved by a container treatment line according to claim 1. The container treatment line has at least two container treatment devices that comprise at least one first container treatment device for treating the containers and a second container treatment device for treating the containers, and which are configured to exchange data with one another in relation to the treatment of the containers, at least one determination device for determining an actual state of at least one predetermined element that is intended for treating the containers with at least one of the at least two container treatment devices, a comparison device for comparing the actual state determined by the determination device with a predetermined state stored in a first database, which is a measurement and/or control state in relation to the operation of an external container treatment line, which comprises at least one container treatment device that is at least partially structurally identical to one of the at least two container treatment devices, and a coordination device for coordinating at least one setting for treating the containers to be made in the first container treatment device with at least one setting for treating the containers to be made with the second container treatment device, wherein the coordination device is configured to carry out its coordination on the basis of the comparison result of the comparison device.

The described container treatment line is configured in such a way that setting the individual parts and media that are used for treating the containers in the line is possible with less effort than before. Here, the setting process can comprise the commissioning and/or the ongoing operation of the line.

As a result, the rejection of preforms and/or finished containers, which is due to an incorrect setting of the container treatment devices and/or its elements, can also be minimized.

Overall, the container treatment devices and/or their elements can be configured highly advantageously in relation to time, manufacturing costs and operating costs. As a result, the embodiment of the container treatment line contributes significantly to ensuring that the containers can be treated uniformly and repeatably, and thus with high quality.

Advantageous further embodiments of the container treatment line are given in the dependent claims.

The coordination device can possibly carry out at least one configuration of the first container treatment device and/or the second container treatment device in the course of its coordination, in order to set the container treatment line for treating the containers.

It is conceivable that the coordination device is configured to carry out self-configuration of the at least two container treatment devices on the basis of the comparison result of the comparison device and/or the alignment result of an alignment device.

In one embodiment, the first predetermined state is an anomaly and/or error that has occurred during the operation of the external container treatment line.

The first predetermined state can possibly be an installation state and/or a configuration state that occurred during the commissioning of the external container treatment line.

The first predetermined state can possibly be a configuration that was made in order to operate the external container treatment line.

Optionally, the determination device includes at least one sensor and/or at least one data evaluation unit for determining the actual state of the at least one predetermined element.

In one embodiment, at least one structural property of the predetermined element is the time or year of manufacture of the predetermined element and/or the at least two container treatment devices.

The predetermined state stored in the first database can be a state of the predetermined element classified as an error, wherein the coordination device is configured to create and output a recommended action that is based on the comparison result of the comparison device.

The container treatment line possibly also has a display device in order to display at least one output from the determination device and/or the comparison device and/or the coordination device.

The container treatment line can also have a coupling device for coupling the treatment of the containers with the first container treatment device and the treatment of the containers with the second container treatment device on the basis of data that are stored in the first database.

The coupling device can be configured to set at least one parameter for treating containers, which is to be used in the second container treatment device when treating the containers, to at least one parameter for treating containers, which is set in the first container treatment device when treating the containers.

Optionally, the determination device is configured to determine the actual state of the at least one predetermined element, a setting of the predetermined element of the first container treatment device or the second container treatment device. Here, the setting of the predetermined element of the first container treatment device or the second container treatment device can comprise at least one of the following settings: an installation height of the predetermined element, a composition of a liquid or gaseous medium, a temperature of an element or of a liquid or gaseous medium, an exposure time, a torque of the predetermined element.

It is conceivable that the at least two container treatment devices comprise at least one blow-molding machine that is configured for blow molding the containers from a preform in each case.

The previously described container treatment apparatus can also comprise at least one heating element for emitting heat radiation for heating preforms.

The at least two container treatment devices can comprise at least one transport device for transporting the containers in the container treatment line.

The at least one transport device can be configured for transporting the containers relative to at least one of the first container treatment device and/or the second container treatment device.

The above-mentioned object is further achieved by a container treatment method, which is configured for treating containers in a container treatment line according to claim 19, which comprises at least two container treatment devices that comprise at least a first container treatment device for treating containers and a second container treatment device for treating containers, and which is configured to exchange data with one another in relation to the treatment of the containers. The container treatment method comprises the following steps: determining, with at least one determination device, an actual state of at least one predetermined element intended for treating the containers with at least one of the at least two container treatment devices; comparing, with a comparison device, the actual state determined by the determination device with a predetermined state stored in a first database, which is a measurement and/or control state in relation to the operation of an external container treatment line, which comprises at least one container treatment device that is at least partially structurally identical to one of the at least two container treatment devices; and coordinating, with a coordination device, at least one setting for treating the containers to be made in the first container treatment device with at least one setting for treating the containers to be made with the second container treatment device, wherein the coordination device carries out its coordination on the basis of the comparison result of the comparison device.

Other possible implementations of the invention also comprise combinations of features or embodiments described previously or below with respect to the exemplary embodiments that are not explicitly mentioned. In doing so, the person skilled in the art will also add individual aspects as improvements or additions to the respective basic form of the invention.

Further embodiments of the invention are the subject matter of the dependent claims and the exemplary embodiments of the invention described below.

The invention is described in more detail below with reference to the accompanying drawing and with reference to exemplary embodiments. In the figures:

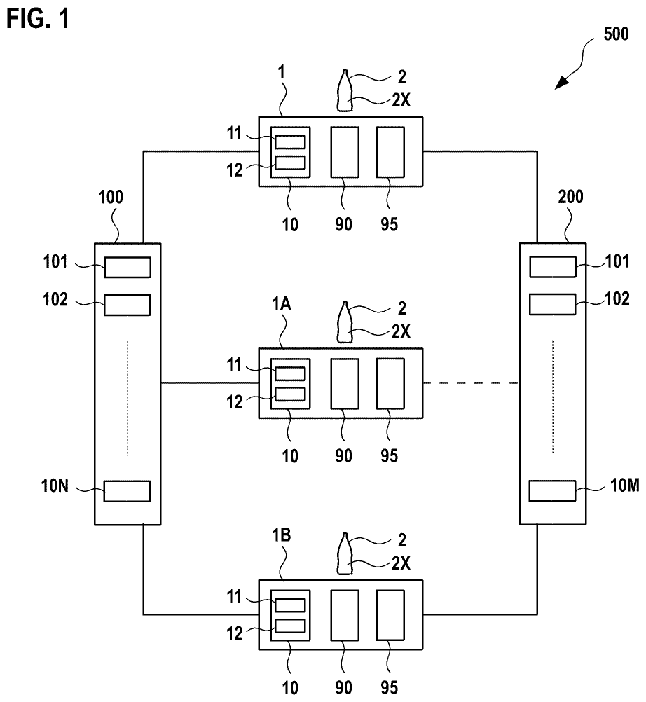

FIG. 1 shows a block diagram of a system in accordance with a first exemplary embodiment, which comprises with container treatment lines and databases; and

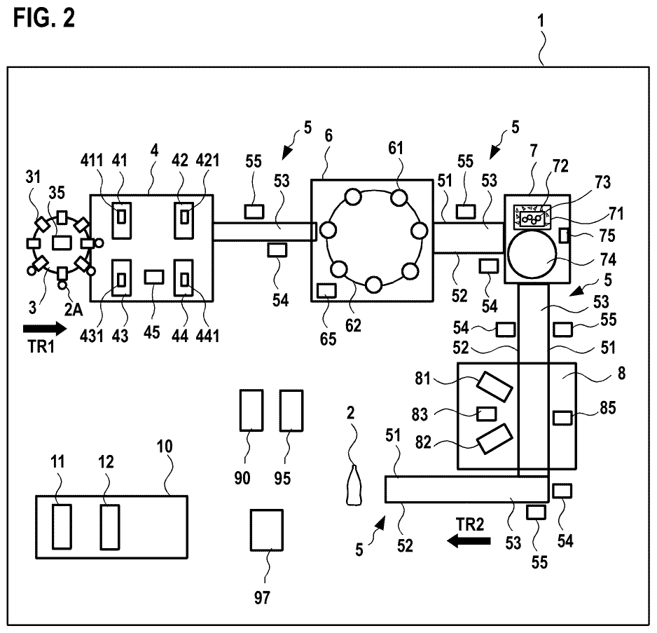

FIG. 2 shows a block diagram of a container treatment line in accordance with the first exemplary embodiment.

In the figures, identical or functionally identical elements are given the same reference signs unless otherwise indicated.

FIG. 1 shows a system 500 with the container treatment lines 1, 1A, 1B, which in each case are configured for treating the containers 2. The containers 2 can optionally be filled with a product 2X. The containers 2 can be glass containers, containers made of pulp, or plastics containers, as previously described for the prior art. The containers 2 are configured in particular as bottles, as shown in FIG. 1, or as cans. The product 2X is, for example, a foodstuff, a beverage, a cleaning agent, or a cosmetic product.

As shown in FIG. 1, the container treatment lines 1, 1A, 1B can access at least one database 100, 200. Access can be via a wired or wireless communication line. The communication line can connect to the Internet. In the specific example of FIG. 1, there are two databases 100 and 200, however, there can only be one database 100 or 200, or there can be more than two databases.

The container treatment lines 1, 1A, 1B are in each case arranged externally from one another. For example, the container treatment line 1 is arranged at a first location and the container treatment line 1A is arranged at a second location. The second location can be in particular in a different city and/or country/state than the first location.

The container treatment lines 1, 1A, 1B of FIG. 1 in each case have at least one control unit 10, one coordination device 90 and one determination device 95. The control unit 10 comprises a comparison device 11 and, optionally, an alignment device 12. The determination device 95, for example, comprises a data evaluation unit and/or at least one sensor and/or at least one camera.

The determination device 95 checks which type of machine is installed. For this purpose, the determination device 95 uses in particular information such as parts lists and/or a nameplate of the particular container treatment line 1, 1A, 1B. The information can be stored in at least one of the databases 100, 200.

The data evaluation unit can evaluate information such as parts lists and/or a nameplate for the particular container treatment line 1, 1A, 1B. The data evaluation device can be software. The determination device 95 does not necessarily require a sensor, which is described below as an option.

The sensor can, for example, detect a physical or chemical property. The physical property is, in particular, a height or shape, etc. The physical property is, in particular, a temperature or pressure, etc. The chemical property is, in particular, a composition of a medium. The medium is, for example, a cooling fluid or a product 2X to be filled into the containers 2. The camera can, for example, record and display the installation location of at least one element of the container treatment lines 1, 1A, 1B.

The container treatment lines 1, 1A, 1B can in each case comprise a different number of container treatment devices. Furthermore, it is possible that container treatment lines 1, 1A, 1B comprise different container treatment devices. Only two of the container treatment lines 1, 1A, 1B possibly have a container treatment device that is identical in both lines 1, 1A, 1B. In particular, container treatment lines 1, 1A, 1B are at least partially structurally identical. The container treatment line 1 is shown in more detail in FIG. 2 and described in more detail below.

The first database 100 can be a central database of the manufacturer of the container treatment lines 1, 1A, 1B, in which measurement and/or control data are stored and/or can be stored. In the database 100, in the example of FIG. 1, data 101, 102, . . . 10N are stored. N is any natural number greater than 1. The data 101 are or comprise a measurement and/or control state of the container treatment line 1A. The data 102 are or comprise a measurement and/or control state of the container treatment line 1B. Furthermore, corresponding data from the container treatment line 1 are stored and/or can be stored in the first database 100.

The comparison device 11 of the control unit 10 can compare the data 101 and/or the data 102 with at least one actual state, which is determined by a determination device 35, 45, 55, 65, 75, 85 of the container treatment line 1 according to FIG. 2. The actual state corresponds, for example, to the actual state of the container treatment line 1 during its configuration. In accordance with another example, the actual state corresponds to the actual state of the container treatment line 1 during its operation. In particular, the actual state is a soiled heating emitter, etc.

The second database 200 can be a central database of the manufacturer of the container treatment lines 1, 1A, 1B, in which structural properties in relation to the container treatment lines 1, 1A, 1B are stored and/or can be stored. In the database 200, for example from FIG. 1, data 201, 202, . . . 20M are stored. M is any natural number greater than 1. The data 201 comprise at least one structural property of a predetermined element 31, 411, 51, 61, 74, 81 of the container treatment line 1A and/or at least one structural property of two container treatment devices 3, 4, 5, 6, 7, 8 of the container treatment line 1, which are shown in more detail in FIG. 2. The data 202 are at least one structural property of a predetermined element 31, 411, 51, 61, 74, 81 of the container treatment line 1B and/or at least one structural property of two container treatment devices 3, 4, 5, 6, 7, 8 of the container treatment line 1B. Furthermore, corresponding data from the container treatment line 1 are stored and/or can be stored in the second database 200.

The optional alignment device 12 of the control unit 10 can align the data 201 and/or the data 202 with at least one structural property of a predetermined element 31, 411, 51, 61, 74, 81 of the container treatment line 1. This is described in more detail below with reference to FIG. 2.

FIG. 2 shows an example of a container treatment line 1. The container treatment line 1A of FIG. 1 and/or the container treatment line 1B of FIG. 2 can be at least partially structurally identical to the container treatment line 1 of FIG. 2.

FIG. 2 shows a container treatment line 1 for manufacturing the containers 2 from the preforms 2A made of plastics material, such as polyethylene terephthalate (PET), polypropylene (PP), etc. The preforms 2A are likewise containers or a preform of the containers 2 or still unfinished containers 2. The finished containers 2 can be, for example, bottles, as shown in FIG. 2, into which a product can be filled. The product can be, in particular, a beverage, a cleaning agent, a cosmetic product, etc. The preforms 2A are shown in FIG. 1 as circles for their opening. For the sake of clarity, in FIG. 1 only one of the preforms 2A, at the beginning (in FIG. 2 on the left) of the series formed by them, is provided with a reference sign.

In the example of FIG. 2, the container treatment line 1 has, as container treatment devices 3, 4, 5, 6, 7, 8, a transport device 3, a heating device 4, a plurality of transport devices 5, a blow-molding machine 6, a filling machine 7 and a decorating machine 8. The transport devices 5 transport the containers 2 in each case between the container treatment devices 4, 6, 7, 8 and out of the container treatment device (decorating machine) 8. The preforms 2A are transported in a first transport direction TR1 into the container treatment line 1. The containers 2 are transported from the container treatment line 1 in a second transport direction TR2.

Naturally, in particular at least one additional container treatment device is present and usable in the container treatment line 1. In particular, a packaging device and/or at least one inspection device can in addition be present in the container treatment line 1, for example. The container treatment line 1 is not limited to the specific embodiment and/or arrangement shown in FIG. 2.

The data 101, 102, . . . 10N of database 100 and/or the data 101, 102, . . . 10N of the database 200 and/or outputs of at least one of the determination devices 35, 45, 55, 65, 75, 85 and/or the comparison device 11 and/or the alignment device 12 and/or the coordination device 90 can be displayed with a display device 97.

The transport device 3 of FIG. 1 is a starwheel that transports preforms 2A into the heating device 4. The transport device 3 also has elements, namely a gripper 31 and a determination device 35. The grippers 31 are configured in order to grip the preforms 2A. The determination device 35 is configured to determine the position and/or the transport speed of the preforms 2A. The determination device 35 has at least one sensor for determining the position and/or the transport speed of the preforms 2A.

In accordance with a specific example, a plurality of modules are arranged on the transport device 3 of FIG. 1, at least for producing and/or drying containers (pulp). The plurality of modules can in particular form a machine for producing a pulp bottle, wherein one of the following two manufacturing methods is possible in the pulp production, namely the “wet” and the “dry” manufacturing method. Here, operating data can comprise at least CAD data/scans of container information relevant to production. With pulp, such container information can be the amount of water (in the wet method), the required pressure, drying conditions, and information on the quality of the educt (pulp educt). Furthermore, other relevant parameters and/or control parameters can and be included.

For the transport device 3 of FIG. 1, the determination device 35 can be or comprise a control unit that, in particular, automatically makes at least one of the following settings:
relevant parameters/modules/control variables of the modules on the transport device 3
information on drying parameters, required pressure, etc. as previously indicated
water content of the preforms 2A and/or containers 2
a registering and synchronizing of a unit controller having a main machine controller
a synchronization within the line 1.

For this purpose, the determination device 35 is configured to receive input data relating to a specification of parameters that are required for producing preforms 2A or containers and/or their forming/hardening process and/or other machine-relevant and/or control parameters parameters/processes, wherein the input data comprise parameter data sets of configured machines and operational data.

The determination device 35 and/or the coordination device 90 is/are configured to create configuration parameters for the transport device 3 or the modules arranged thereon by the comparison device 12, which can be an artificial intelligence module (AI module), wherein the configuration parameters are based on at least the received input data.

Furthermore, the determination device 35 and/or the coordination device 90 are configured to apply configuration parameters in order to configure a plurality of modules of the transport device 3 and/or the modules arranged thereon, wherein the plurality of modules are structured at least for producing and/or forming and/or hardening and/or transporting preforms and/or containers 2.

The application of the configuration parameters can be carried out with a coupling device that sets at least one parameter for treating the containers 2, 2A, which is to be used in the second container treatment device 4 when treating the containers 2, 2A, to at least one parameter for treating the containers 2, 2A, which is set in the first container treatment device 3 when treating the containers 2, 2A.

This makes it possible for the transport device 3 or the at least one module arranged on it to configure itself, for example on the basis of the following data.

A) A customer 1 is using a pulp container x→as a result the optimal parameter set M has been obtained (20% water content, . . . ).

B) A customer 2 has a new IBN: Pulp educt y is highly similar to the educt specification (for container x) of customer 1. Due to the minimal deviation, the content must be increased by 1% on the basis of knowledge (know-how) gained from the development process. This constitutes a self-configuration, which is possible through the use of the determination device 35 and/or the coordination device 90, which perform a database/big data alignment. The machine for customer 2 has learned that the extra 1% of water is not sufficient, but that an additional 2% water content is required.

C) This results in an advantage for customer 3, who likewise has a pulp educt analogous to pulp container y. Therefore, for customer 3, the water content is increased by 2% due to the use of the determination device 35 and/or the coordination device 90. In other words, the water content is increased by 2% by the at least one module arranged on the transport device 3, in particular automatically.

In the heating device 4, the preforms 2A are heated to a desired forming temperature with the aid of heating modules 41, 42, 43, 44, more precisely their elements, namely heating emitters 411, 421, 431, 441. Each of the heating modules 41, 42, 43, 44 has at least one heating emitter 411, 421, 431, 441. The heating device 4 also has as a further element a determination device 45 for determining the temperature of the heating emitters 411, 421, 431, 441 and/or the temperature between the heating modules 41, 42, 43, 44 and/or the position and/or the transport speed of the preforms 2A relative to the n heating modules 41, 42, 43, 44. The determination device 45 has at least one sensor for determining the temperature and/or the position and/or the transport speed.

The transport device 5 of FIG. 1 is a linear conveyor that comprises as elements an optional first railing 51, an optional second railing 52, a receiving element 53 for receiving the preforms 2A or the containers 2, at least one drive 54, and a determination device 55. The determination device 55 is configured to determine the position and/or the transport speed of the preforms 2A or containers 2. The determination device 55 has in particular at least one sensor for determining the position of the preforms 2A and/or one of the optional railings 51, 52, in particular relative to one of the other elements of the transport device 5, and/or for determining the transport speed of the preforms 2A, in particular relative to one of the other elements of the transport device 5.

For the transport device 5 of FIG. 1, the determination device 55 can be or comprise a control unit that, in particular, automatically makes at least one of the following settings:
relevant parameters/modules/control variables of the transport device 5
information on transport parameters, such as position and/or transport speed of the preforms 2A or containers 2
information on operating supplies (OS) used, in particular belt lubrication (wet belt lubrication, dry belt lubrication, hybrid, solids content, silicone-containing, . . . )
a registering and synchronizing of a unit controller having a main machine controller
a synchronization within the line 1.

For this purpose, the determination device 55 is configured to receive input data that require a specification of parameters relevant to the transport device 5 and/or of control parameters/processes and/or other machine-relevant parameters, wherein the input data comprise parameter data sets from already configured machines and operational data. For the transport device 5 of FIG. 1, the parameters can be at least one transport parameter. If the transport device 5 of FIG. 1 does not have a dry running chain, the parameters can, for example, be at least one belt lubrication parameter.

The determination device 55 and/or the coordination device 90 is/are configured to create configuration parameters for the transport device 5 by the comparison device 12, which can be an artificial intelligence module (AI module), wherein the configuration parameters are based on at least the received input data.

Furthermore, the determination device 55 and/or the coordination device 90 are configured to apply configuration parameters in order to configure a plurality of modules of the transport device 5, wherein the plurality of modules are structured at least for transporting containers of the containers 2.

This makes it possible for the transport device 5 to configure itself, for example on the basis of the following data.

A) A customer 1 has a bottle a with a tilt angle x and size/material/shape p. Here, the dry belt lubrication of the transport device 5 runs with the cycle times t1 and the belt lubrication concentrations of the KIC-OS CG1 n %.

B) A customer 2 has an almost analogous bottle, differing only in the tilt angle, namely tilt angle=y. On the basis of the database alignment, the concentration of KIC-OS CG1 is increased to (n+1) %.

Thus, the transport device 5 learns from customer 2 that n % would have fit—but from the silicone-containing KIC-OS CG2.

C) A customer 3 has a bottle analogous to the one for customer 2. On the basis of the data from customer 1 and customer 2, with the determination device 55 and/or the coordination device 90, it follows that KIC-OS CG2 is directly used with n % for customer 3.

The blow-molding machine 6 has as a container treatment element(s) at least one blow mold 61, a starwheel 62 and a determination device 65. In the blow mold 61, the preheated preforms 2A are blown into the container 2 with the desired shape. The starwheel 62 moves the at least one blow mold 61 between the two adjacent transport devices 5 at the inlet and outlet of the blow-molding machine 6. The determination device 65 has at least one sensor for determining the pressure in at least one of the blow molds 61 and/or the position of one of the blow molds 61, in particular relative to one of the transport devices 5, and/or the opening dimension of one of the blow molds 61.

The blow-molding machine 6 has a plurality of modules, at least for producing and/or stretch-blow-molding the containers 2 made of plastics material or pulp.

The determination device 65 can be or comprise a control unit that, in particular, automatically makes at least one of the following settings:
relevant parameters/modules/control variables of at least one blow mold 61, in particular information on blow parameters, such as blow pressure, etc.
selection of stretch-blow-molding parameters
oven output
check of contamination+adjusted cleaning
a registering and synchronizing of a unit controller having a main machine controller
a synchronization within the line 1.

For this purpose, the determination device 65 is configured to receive input data relating to a specification of parameters that are required for producing the containers 2 from the preforms 2A and/or their forming process, in particular, e.g., those relating to at least one stretch-blow-molding process and/or forming/hardening process, and/or other machine-relevant parameters and/or control parameters/processes, wherein the input data comprise parameter data sets of configured blow-molding machines and their operating data (operational data).

The determination device 65 and/or the coordination device 90 is/are configured to create configuration parameters for the blow-molding machine 6 by the comparison device 12, which can be an artificial intelligence module (AI module), wherein the configuration parameters are based on at least the received input data.

Furthermore, the determination device 65 and/or the coordination device 90 is/are configured to apply the configuration parameters in order to configure the blow-molding machine 6 or its blow molds 61, wherein the blow-molding machine 6 or its blow molds 61 are structured at least for blowing and/or hardening containers 2.

This makes it possible for the blow-molding machine 6 to configure itself on the basis of data that are already stored in one of the databases 100, 200.

The filling machine 7 has as a container treatment element at least one filling container 71, at least one cooling medium 72, at least one filling medium or product 73, at least one filler 74 for filling the at least one filling medium or product 73 into a container 2 and a determination device 75. The determination device 75 has at least one sensor for determining the temperature of the at least one cooling medium 72 and/or for determining the temperature of the at least one filling medium or product 73 and/or for determining the composition of the at least one cooling medium 72 and/or for determining the composition of the at least one filling medium or product 73 and/or for determining the filling pressure exerted by the filler 74.

The determination device 75 can be or comprise a control unit that performs a dedicated/specific incoming goods check in order to perform a check of the specification of the operating supplies (OS) of a cooling tower for the cooling medium 72 and to regulate and/or control it based on the specifications. For example, there are a plurality of modules available for at least one application that requires a cooling tower. The determination device 75 can be configured to, in particular, automatically make at least one of the following settings:
relevant parameters/modules/control variables of the machine
cooling tower functions, for example including temperature profile
disinfection concept
microbiological contamination
scale formation
a registering and synchronizing of a unit controller having a main machine controller
a synchronization within the line 1.

For this purpose, the determination device 75 is configured to receive input data relating to a specification of parameters relating to at least one cooling tower process/step and/or a temperature profile, wherein the input data comprise parameter data sets of configured machines and operating data (operational data).

The determination device 75 and/or the coordination device 90 is/are configured to create configuration parameters for the cooling tower of the filling machine 7 by the comparison device 12, which can be an artificial intelligence module (AI module), wherein the configuration parameters are based on at least the received input data.

Furthermore, the determination device 75 and/or the coordination device 90 are configured to apply the configuration parameters in order to configure the filling machine 7 or its cooling tower, in particular a plurality of modules of the machine 7, wherein the plurality of modules are structured at least for cooling [cooling tower function] and/or thermal treatment of the containers 2.

This makes it possible for the filling machine 7 or its modules for the cooling tower to configure itself or themselves on the basis of data that are already stored in one of the databases 100, 200. For example, self-configuration takes place on the basis of the following data:

A) A customer 1 has a line a, for which the optimal parameter set M has been obtained, namely cooling tower program including temperature profile, scale prevention, disinfection concept/concentrations, . . . here, specifically: a disinfectant concentration of 20 ppm is usually required.

B) The customer 1 puts a new line into operation, namely line b. The line b differs only minimally from the line a. On the basis of the previous database values, this deviation usually leads to a disinfection requirement of 22 ppm of disinfectant. This is possible through a database/big data alignment, so that the line b configures itself.

C) The line b for customer 1 has learned that 22 ppm is not sufficient, but that 24 ppm is needed instead.

D) The advantage for customer 2, who likewise has one more or less analogous line to line b, is that customer 2 is dosed with 24 ppm of disinfectant from the outset.

The described self-configuration of the cooling tower or the filling machine 7 has the great advantage that no microbiological contamination occurs. The reason for this is that without the appropriate minimum disinfection, a microbiological contamination occurs, producing unwanted rejects and plant downtimes.

The decorating machine 8 has as a container treatment element at least one decorating unit 81, 82, at least one decorating medium 83, and a determination device 85. The decorating unit 81, 82 is a labeling and/or printing unit that can decorate a container 2 with at least one label and/or a print on the container and/or the label. The at least one decorating medium 83 can comprise a label and/or a printing ink and/or glue. The determination device 85 has at least one sensor for determining the position of one of the containers 2 relative to at least one labeling and/or printing unit 81, 82 and/or for determining the position of the at least one decorating medium 83 and/or for determining the composition of the at least one decorating medium 83.

For the decorating machine 8 of FIG. 1, the determination device 85 can be or comprise a control unit that, in particular, automatically makes at least one of the following settings:
relevant parameters/modules/control variables of the decorating machine 8, which is in particular a machine for, in particular digital, direct printing
information on printing parameters
information on operating supplies (OS) used, in particular type, concentration, color, etc.
a registering and synchronizing of a unit controller having a main machine controller
a synchronization within the line 1.

For this purpose, the determination device 85 is configured to receive input data that in particular comprise at least one printing parameter and/or hardening parameter and/or other machine-relevant parameters and/or control parameters/processes, wherein the input data comprise parameter data sets from already configured machines and operational data.

The determination device 85 and/or the coordination device 90 is/are configured to create configuration parameters for the decorating machine 8 by the comparison device 12, which can be an artificial intelligence module (AI module), wherein the configuration parameters are based on at least the received input data.

Furthermore, the determination device 85 and/or the coordination device 90 is/are configured to apply the configuration parameters in order to configure the modules of the decorating machine 8, wherein the modules of the decorating machine 8 are structured at least for printing on containers 2.

This makes it possible for the decorating machine 8 to configure itself, for example on the basis of the following data.

A) A customer 1 has a container, in particular a bottle, X, on which a printed image a is to be produced. This results in the printing and hardening parameters M

B) A customer 2 has a container, in particular a bottle, Y, on which a printed image b is to be produced that is highly similar to the print image a for customer 1. Therefore, the same inks are used and the printing and hardening parameters M are loaded.

The machine for customer 2 learns that the printing and hardening parameters M must be adjusted on the basis of the container specification of Y, since this is the greater influencing factor for the customer. This results in a parameter set N for customer 2.

C) A customer 3 likewise has the container, in particular bottle, Y, on which a printed image c is to be produced. Accordingly, the parameter set N is loaded directly and minimally adjusted to the printed image c of customer 3.

As previously described for the example of FIG. 2 for some of the machines 6 to 8 and the transport device 3 and the modules possibly arranged on it, along with the transport devices 5, the following is possible for lines 1, 1A, 1B. The comparison device 11 carries out a comparison with data in the database 100. Furthermore, the optional alignment device 90 can perform an alignment of at least one structural property of, for example, the heating module 411 of the container treatment line 1 with at least one predetermined structural property of the heating module 411 of the container treatment line 1A and/or at least one predetermined structural property of the at least two container treatment devices 4, 6 that are stored in the database 200.

For the lines 1, 1A, and 1B, it is thus possible to create configuration data. This comprises the following steps:
creating a parameterization model based on the received input data; and
training, by the artificial intelligence module (AI module), the parameterization model based on the parameter data sets of configured labeling machines, wherein the configuration parameters are derived from the trained parameterization model.

Creating configuration data makes self-configuration based on database knowledge possible, in particular data in at least one of databases 100, 200. The database knowledge can be comprehensive and comprises machine know-how from the machine manufacturer, from research to commissioning of the machine or the line 1, 1A, 1B to application at the end customer. Furthermore, all know-how in relation to operating supplies and/or machine/method/operating supplies behavior can be stored in at least one of databases 100, 200.

Thus, this database knowledge, in particular the data in at least one of the databases 100, 200, makes possible not only self-configuration but also a response to anomalies during the ongoing process. This is a significant contribution to operational safety.

Furthermore, this database knowledge forms an elementary building block for dedicated/specific incoming goods check. In particular, it is possible to check the specification of the operating supplies and to regulate and/or control them based on the specifications.

Furthermore, the application of the configuration parameters can be carried out with a coupling device that sets at least one parameter for treating the containers 2, 2A, which is to be used in the second container treatment device when treating the containers 2, 2A, to at least one parameter for treating the containers 2, 2A, which is set in the first container treatment device when treating the containers 2, 2A, as previously mentioned as an example for the container treatment devices 3, 4.

In accordance with a second exemplary embodiment, only one database 100 is present. At least some of the data that were previously described in relation to the database 100 are stored in the database 100. Furthermore, at least some of the data previously described in relation to the database 200 are stored in the database 100.

The self-configuration of at least one of the container treatment lines 1, 1A, 1B, in particular their container treatment devices 3 to 8, is carried out in the same way as previously described for the first exemplary embodiment.

Furthermore, at least one of the lines 1, 1A, 1B can comprise a washing machine for the food industry, in particular for the beverage industry, as a container treatment device. Here, the washing machine/container treatment device has a plurality of modules, at least for cleaning containers. The containers can be made of materials such as glass, refPET (PET=polyethylene), or “ref-pulp.”

The washing machine can be or comprise a determination device and/or a control unit that, in particular, automatically makes at least one of the following settings:
relevant parameters/modules/control variables of the washing machine
selection of cleaning parameters
check of scale formation
check of caustic carryover
measurement of label penetration depth (ammeter measurement)
a registering and synchronizing of a unit controller having a main machine controller
a synchronization within at least one of the container treatment lines 1, 1A, 1B.

For this purpose, the determination device of the washing machine is configured to receive input data, which in particular comprise at least one cleaning parameter, energy, temperature, and/or other machine-relevant parameters and/or control parameters/processes, wherein the input data comprise parameter data sets from already configured machines and operational data.

The determination device of the washing machine and/or the coordination device 90 is/are configured to create configuration parameters for the washing machine by the comparison device 12, which can be an artificial intelligence module (AI module), wherein the configuration parameters are based on at least the received input data.

Furthermore, the determination device of the washing machine and/or the coordination device 90 are configured to apply the configuration parameters to configure the modules of the washing machine, wherein the modules of the washing machine are structured at least for cleaning containers 2.

This makes it possible for the washing machine to configure itself, for example on the basis of the following data.

A) A customer 1 is using a container, in particular a bottle a and a label b and adhesive c. As a result, the optimal parameter set M has been obtained, which comprises the addition of the specific KIC additive x at 0.5%, since otherwise the caustic penetration at the label is insufficient. This would result in an insufficient cleaning result.

B) A customer 2 has a new washing machine. Furthermore, a label d is used which is of comparable specification, but is 0.1 mm thicker. Therefore, the additive concentration in the washing machine is increased to 0.6%, since otherwise the caustic penetration is likely to be insufficient again. This adjustment is possible through database/big data alignment, so that a self-configuration takes place in the washing machine.

The washing machine for customer 2 has learned that the additive concentration needs to be increased even further, namely to 0.65%.

C) A customer 3 has the advantage of using this data, since customer 3 likewise uses a label analogous to label d. For customer 3, the additive concentration is increased to 0.65% from the outset.

In accordance with a third exemplary embodiment, at least one of the lines 1, 1A, 1B has a pasteurizer for the food industry, in particular for the beverage industry, as a container treatment device. Here, the pasteurizer has a plurality of modules at least for pasteurizing/treating/thermal treatment of the containers 2, which comprise cans or are made of glass or plastics material, in particular PET, or pulp or at least one other suitable material.

The pasteurizer can be or comprise a determination device and/or a control unit that uses information on temperature profiles/pasteurization profiles, contamination/scale formation of the pasteurizer, microbiological contamination, disinfection programs/concepts, conveyor speed, etc. The pasteurizer, more precisely its determination device and/or control unit, can be configured to automatically in particular make at least one of the following settings:
relevant parameters/modules/control variables of the pasteurizer
pasteurization profile, including temperature profile
disinfection concept
microbiological contamination
scale formation
a registering and synchronizing of a unit controller having a main machine controller
a synchronization within at least one of the container treatment lines 1, 1A, 1B.

For this purpose, the determination device of the pasteurizer is configured to receive input data that in particular relate to at least one pasteurization process/step and/or temperature profile, and/or other machine-relevant parameters and/or control parameters/processes, wherein the input data comprise parameter data sets from already configured machines and operating data (operational data).

The determination device of the pasteurizer and/or the coordination device 90 is/are configured to create configuration parameters for the pasteurizer by the comparison device 12, which can be an artificial intelligence module (AI module), wherein the configuration parameters are based on at least the received input data.

Furthermore, the determination device of the pasteurizer and/or the coordination device 90 are configured to apply the configuration parameters in order to configure the modules of the pasteurizer.

This makes it possible for the pasteurizer to configure itself, for example on the basis of the following data:

A) A customer 1 has a pasteurization program including temperature profile, scale prevention, disinfection concept/concentrations, etc. In particular, when checking all specifications [container material, etc.], an average of 0.4% container bursts can occur. This usually requires a disinfectant concentration of 20 ppm.

B) A customer 2 has a new line with a pasteurizer, in which a bottle b is used that differs minimally in its specification from the specification for customer A. On the basis of previous database values, this deviation typically results in 0.5% container bursts (total). As a result, 22 ppm of the disinfectant is required, which is determined through a database/big data alignment. The pasteurizer is thus self-configuring, since the pasteurizer for customer 2 has learned that the 22 ppm are not sufficient, since an average of 0.6% container bursts occur. Thus, the pasteurizer configures itself to 24 ppm.

C) The advantage for customer 3 is that he likewise uses a bottle analogous to bottle b. Therefore, his pasteurizer configures itself from the outset to a dosage of 24 ppm of disinfectant.

The described self-configuration of the pasteurizer has the great advantage that no microbiological contamination occurs. The reason for this is that without the appropriate minimum disinfection, a microbiological contamination occurs, producing unwanted rejects and plant downtimes.

In accordance with a fourth exemplary embodiment, at least one of the lines 1, 1A, 1B has a CIP machine. The CIP machine offers consistent cleaning processes that ensure the trouble-free and microbiologically sound operation of the associated lines 1, 1A, 1B, thereby also ensuring product quality. The cleaning concept can be carried out manually or automatically, wherein the cleaning concept is perfectly matched to the plant components to be cleaned of the container treatment devices 3 to 8 or to the number of (filling) lines 1, 1A, 1B.

The area of application of the CIP machine is in cleaning automatically controlled fillers, (short-time) heating plants, mixers, syrup rooms along with piping systems and tanks. The CIP machine has a completely flexible machine configuration with regard to the size and number of tanks, parallel cleaning rails and/or the dosing of chemicals.

The CIP machine offers excellent cleaning results by controlling the cleaning processes according to conductivity, temperature and time. Here, minimizing media losses and wastewater by automatic processes is possible. A continuous target/actual value comparison and automatic correction take place.

In particular, the piping is made of stainless steel, material AISI 316L, and/or the tanks are made of stainless steel, material AISI 304, optionally AISI 316L. Pumps, heat exchangers and control cabinets can be mounted on round tube frames. A hygienic structure of the fittings, pumps, sensors, piping and structural support elements is advantageous. Temperature and conductivity measurements in the return line are possible.

Here, the CIP machine has a plurality of modules, at least for cleaning a line 1, 1A, 1B, for treating the containers 2, which comprise cans or are made of glass or plastics material, in particular PET, or pulp or at least one other suitable material.

The CIP machine can be or comprise a determination device and/or a control unit that uses information on production-relevant container information, information on cleaning programs, operating supplies/raw materials used, etc. The CIP machine, more precisely its determination device and/or control unit, can be configured to automatically make in particular at least one of the following settings:
relevant parameters/modules/control variables of the CIP machine
information on cleaning programs
information on operating supplies/raw materials used
information on concentrations, dwell times, etc.
a registering and synchronizing of a unit controller having a main machine controller
a synchronization within at least one of the container treatment lines 1, 1A, 1B.

For this purpose, the determination device of the CIP machine is configured to receive input data that in particular relate to at least one cleaning parameter and/or concentration parameter, and/or other machine-relevant parameters and/or control parameters/processes, wherein the input data comprise parameter data sets from already configured machines and operating data (operational data).

The determination device of the CIP machine and/or the coordination device 90 is/are configured to create configuration parameters for the CIP machine by the comparison device 12, which can be an artificial intelligence module (AI module), wherein the configuration parameters are based on at least the received input data.

Furthermore, the determination device of the CIP machine and/or the coordination device 90 are configured to apply the configuration parameters in order to configure the modules of the CIP machine.

This makes it possible for the CIP machine to configure itself, for example on the basis of the following data:

A) A customer 1 fills beer into a container, in particular a bottle. Here, a CIP cleaning program y was selected as the optimal parameter set M, in which a cleaning booster AD is used at a concentration of x1% with a contact time of t1.

B) Customer 2 likewise fills beer into a container, in particular a bottle b. Due to the differences between containers a and b, a cleaning booster AD with a concentration of x2% and a contact time of t2 is selected.

The CIP machine for customer 2 has learned that x2% with contact time t2 is not sufficient, but that x3% and t3 must be set.

C) The advantage for customer 3 is that he likewise uses a bottling process analogous to that of customer 2. Therefore, customer 3 can choose concentration and time analogous to that of customer 2 (x3% and t3). Therefore, his CIP machine is configured from the outset with a setting like that for customer 2.

The described self-configuration of the CIP machine has the major advantage that no microbiological contamination occurs. The reason for this is that without the appropriate minimum disinfection, a microbiological contamination occurs, producing unwanted rejects and plant downtimes.

In accordance with a fifth exemplary embodiment, at least one of the lines 1, 1A, 1B has a recycling machine for the food industry, in particular for the beverage industry. Here, the recycling machine has a plurality of modules, at least for recycling containers 2, which comprise cans or are made of glass or plastics material, in particular PET, or pulp or at least one other suitable material.

The recycling machine can be or comprise a determination device and/or a control unit that uses information and/or operational data that comprises at least CAD data/scans of production-relevant container information, recycling parameter information, information on decoloring (“smart decoloring”), information on required operating supplies such as additives, defoamers, decoloring reagents, scale prevention agents, etc. The recycling machine, more precisely its determination device and/or control unit, can be configured to automatically make in particular at least one of the following settings:
relevant parameters/modules/control variables of the recycling machine
information on recycling parameters
information on required operating supplies, in particular additives, defoamers, decoloring reagents, scale prevention agents, etc., including concentrations, residence/contact times, etc.
a registering and synchronizing of a unit controller having a main machine controller
a synchronization within at least one of the container treatment lines 1, 1A, 1B.

For this purpose, the determination device of the recycling machine is configured to receive input data that in particular relate to at least one recycling parameter and/or information on required/used operating supplies, such as additives, defoamers, decoloring reagents, scale prevention agents, etc., and/or other machine-relevant parameters and/or control parameters/processes, wherein the input data comprise parameter data sets from already configured machines and operating data (operational data).

The determination device of the recycling machine and/or the coordination device 90 is/are configured to create configuration parameters for the recycling machine by the comparison device 12, which can be an artificial intelligence module (AI module), wherein the configuration parameters are based on at least the received input data.

Furthermore, the determination device of the recycling machine and/or the coordination device 90 are configured to apply the configuration parameters in order to configure the modules of the recycling machine.

This makes it possible for the recycling machine to configure itself, for example on the basis of the following data:

A) A customer 1 recycles PET plastics material of specification a. This results in the operating supplies (OS) set M along with the method parameters N.

B) A customer 2 likewise recycles PET plastics material. However, his starting material for recycling (pool) differs somewhat from specification a, so that customer 2 has a specification b. As a result, for customer 2 the operating supplies (OS) set M is adjusted to the operating-supplies (OS) set O.

The recycling machine for customer 2 learns that the parameters likewise need to be adjusted with regard to P.

C) For customer 3, whose specification is similar to the specification b of customer 2, the operating supplies (OS) set O is selected directly for recycling, which is also adjusted with regard to parameter P. A database alignment thus takes place, wherein the machine of customer 3 configures itself.

The described self-configuration of the recycling machine has the major advantage that unwanted rejects and plant downtimes can be minimized.

In accordance with a sixth exemplary embodiment, at least one of the lines 1, 1A, 1B has a smart-link machine for the food industry, in particular for the beverage industry. Here, the smart-link machine creates a link between a preform manufacturing machine and a blow-molding machine. The preform manufacturing machine can be, in particular, an injection molding machine or a compression molding machine.

The smart-link machine can be or comprise a determination device and/or a control unit that comprises a plurality of modules at least for producing and/or stretch-blow-molding containers (usually PET-possibly also pulp in the future), etc. The smart-link machine, more precisely its determination device and/or control unit, can be configured to automatically make in particular at least one of the following settings:
relevant parameters/modules/control variables of the smart-link machine
selection of stretch-blow-molding parameters
oven output
check of contamination+adjusted cleaning
a registering and synchronizing of a unit controller having a main machine controller
a synchronization within at least one of the container treatment lines 1, 1A, 1B.

For this purpose, the determination device of the smart-link machine is configured to receive input data that in particular relate to at least one stretch-blow-molding process and/or forming/hardening process, etc. and/or other machine-relevant parameters and/or control parameters/processes, wherein the input data comprise parameter data sets from already configured machines and operating data (operational data).

The determination device of the recycling machine and/or the coordination device 90 is/are configured to create configuration parameters for the smart-link machine by the comparison device 12, which can be an artificial intelligence module (AI module), wherein the configuration parameters are based on at least the received input data.

Furthermore, the determination device of the smart-link machine and/or the coordination device 90 are configured to apply the configuration parameters in order to configure the modules of the smart-link machine.

This makes it possible for the smart-link machine to configure itself, for example on the basis of the following data:

A) A customer 1 is using a container, in particular a bottle a and preform x. As a result, the optimal parameter set M has been obtained, with which the temperature is, e.g., 72 degrees, and a stretch-blow-molding process is used.

B) A customer 2 has a new line 1 that is to be put into operation. Here, a preform y is 0.1 mm thicker at a relevant location, for which reason the temperature is increased from 72° C. to 73° C., since the stretch-blowing process requires more heat in this case. Such an adjustment is possible through database/big data alignment. Thus, the line 1 of customer 2 operates in a self-configuring manner.

The smart-link machine for customer 2 has learned that 73 degrees are not sufficient, but 74 degrees are required.

C) A customer 3 has the advantage that he likewise uses a preform analogous to preform y of the customer 2. Therefore, the smart-link machine automatically increases the temperature by 2 degrees (from 72 to 74) for customer 3.

The described self-configuration of the smart-link machine has the major advantage that unwanted rejects and plant downtimes can be minimized.

In accordance with a seventh exemplary embodiment, at least one of the databases 100, 200 comprises external big data. For this purpose, correlations between errors and causes of other identical/similar machines are stored in a worldwide database. This can include, for example, relationships between machines and process parameters, method-specific and application-specific parameters, and environmental conditions. Relationships between machines and process parameters include, e.g., a blow curve. Method-specific and application-specific parameters include, e.g., the type of cleaning in combination with water quality and water pretreatment. Environmental conditions include, e.g., a lack of control over relevant environmental parameters; the influence of improper storage.

Additionally, at least one of the databases 100 or 200 can comprise internal big data. For this purpose, knowledge (know-how) of the manufacturer of the lines 1, 1A, and 1B is stored in a worldwide database. These can involve, for example, parts lists and production version levels. For example, it can be stored that a supplier change took place in 2017. If an error thus occurs in machines from before 2017, the error must lie in the component that was installed prior to 2017. It thus involves knowledge (know-how) of the manufacturer, which can lead to recommended actions only through internal big data. External big data would not have been able to provide any recommended action.

At least one of the determination devices of the lines 1, 1A, 1B and/or the coordination device 90 is/are configured to output at least one recommended action in the event of a deviation from the mean. An example of this is that a CoA preform is within the specification, wherein however, one analysis parameter deviates upwards compared to the worldwide data set, which is a potential source of error.

At least one of the determination devices of the lines 1, 1A, 1B and/or the coordination device 90 is/are configured to output at least one recommended action in the event of a correspondence between its own deviation or error and a deviation or error in another machine.

The following procedure can be used to monitor a cooling circuit in accordance with the present exemplary embodiment. Parameters characteristic of cooling water are measured by sensors, in particular that the cooling water quality is no longer adequate due to deposits. A comparison with external big data reveals that other customers with identical or similar machines have the same problem due to a poorly coordinated disinfection/hardness stabilization concept, and the solution to this problem was a new disinfection/hardness stabilization concept. A comparison with internal big data reveals that an internal note exists regarding the structuring phase. Accordingly, the customer was advised that a lack of separation between the pasteurizer and the cooling tower can lead to problems with the process water quality. Nevertheless, a special machine was built according to the customer's wishes. This information would not be apparent from external big data, but it is the solution here.

The following procedure can be used to monitor a filter in accordance with the present exemplary embodiment. Parameters characteristic of filters are measured by sensors, in particular that a compressed air filter is clogged. A comparison with external big data reveals that other customers with identical or similar machines have the same problem at position X. However, no clear recommended action is possible. Comparison with internal big data reveals that a supplier change took place in 2017, since errors occurred with machines older than 2017. This indicates that the error was due to the old filter. This is knowledge (know-how) that can only lead to recommended actions through internal big data. This knowledge would not be apparent through ongoing operations. This means that the error only occurs in machines manufactured before 2017. The consequence of this is that this specific filter is the source of the error. Therefore, recommended actions are issued by providing information to the customer with the error and by providing information to the customer with the old filter.

In accordance with the seventh exemplary embodiment, parameters that are relevant to the state in one of the lines 1, 1A, 1B are compared with external/internal big data, and recommended actions are also output to change the state or that relate to the state.

Possible data that can be collected and compared with external/internal big data include data on energy consumption, media consumption, consumables/operating materials (lubricants, cleaning agents), spare parts, and electronic nameplates.

The sixth exemplary embodiment has the advantage that recommended actions can be output at an early stage.

All previously described embodiments of the container treatment line 1 and the previously described method can be used individually or in all possible combinations. The features of at least two exemplary embodiments of the first to seventh exemplary embodiment can be combined in any way. In addition, the following modifications are particularly conceivable.

The parts shown in the figures are schematic diagrams and may differ in exact embodiment from the shapes shown in the figures as long as their previously described functions are ensured.

The number of treatment elements of the container treatment devices 3, 4, 5, 6, 7, 8 is freely selectable.

The number of heating elements 411 of the heating module 41 can be selected as required. The same applies accordingly to the number of heating elements 421, 432, 442 of the heating modules 42, 43, 44. In at least one of the heating modules 41 to 44, in particular, more or fewer heating elements 411 than those shown in the figures can be used.

Furthermore, the number of heating modules (411 to 414) can be selected as required. More or fewer heating modules 411 to 414 than those shown in the figures can be used.

Furthermore, the number of blow molds (61) can be selected as desired. Additionally or alternatively, the arrangement of the blow molds 61 in the blow-molding machine 6 can be selected as desired.

The transport device 5, which is downstream of the filling machine 7, can at least in portions be a mass conveyor with which the containers 2 are transported side by side in the direction of the decorating machine 8. The transport device 5, which is downstream of the decorating machine 8, can be a mass conveyor at least in portions.

Furthermore, the number and/or combination of the aforementioned machines can be selected as required or line 1, 1A, 1B.

List of Reference Signs

| | |
|---|---|
| 1, 1A, 1B | container treatment line |
| 2 | container |
| 2A | preform |
| 3 | container treatment device (transport device) |
| 4 | container treatment device (heating device) |
| 5 | container treatment device (transport device) |
| 6 | container treatment device (blow-molding |
| | machine) |
| 7 | container treatment device (filling machine) |
| 8 | container treatment device (decorating machine) |
| 10 | control unit |
| 11 | comparison device |
| 12 | alignment device |
| 31 | gripper |
| 35 | determination device (sensor) |
| 41 to 44 | first to fourth treatment module (heating module) |
| 45 | determination device (sensor) |
| 411 | first treatment element (heating emitter, reflector) |
| 421 | second treatment element (heating emitter, |
| | reflector) |
| 431 | third treatment element (heating emitter, reflector) |
| 441 | fourth treatment element (heating emitter, |
| | reflector) |
| 51 | first treatment element (railing) |
| 52 | second treatment element (railing) |
| 53 | third treatment element (receiving element) |
| 54 | fourth treatment element (drive) |
| 55 | determination device (sensor) |
| 61 | first treatment element (blow mold) |
| 62 | second treatment element (starwheel) |
| 65 | determination device (sensor) |
| 71 | treatment element (filling container) |
| 72 | treatment element (cooling medium) |
| 73 | filling medium |
| 74 | treatment element (filler) |
| 75 | determination device (sensor) |
| 81 | first treatment element (decorating unit) |
| 82 | second treatment element (decorating unit) |
| 83 | third treatment element (decorating medium) |
| 85 | determination device |
| 90 | coordination device |
| 95 | determination device (sensor, data evaluation |
| | unit, camera) |
| 97 | display device |
| 100 | first database |
| 101, 102, 103 | data, predetermined state |
| 10N | data, predetermined state |
| 10M | data, predetermined state |
| 200 | second database |
| TR1 | first transport direction |
| TR2 | second transport direction |

1. A container treatment line, having
at least two container treatment devices, which comprise at least one first container treatment device for treating the containers and a second container treatment device for treating the containers, and which are configured to exchange data with one another in relation to the treatment of the containers,
at least one determination device for determining an actual state of at least one predetermined element that is intended for treating the containers with at least one of the at least two container treatment devices,
a comparison device for comparing the actual state determined by the determination device with a predetermined state stored in a first database, which is a measurement and/or control state in relation to the operation of an external container treatment line, which comprises at least one container treatment device that is at least partially structurally identical to one of the at least two container treatment devices, and
a coordination device for coordinating at least one setting for treating the containers to be made in the first container treatment device with at least one setting for treating the containers to be made with the second container treatment device,
wherein the coordination device is configured to carry out its coordination on the basis of the comparison result of the comparison device.

2. The container treatment line according to claim 1, wherein the coordination device carries out at least one configuration of the first container treatment device and/or the second container treatment device in the course of its coordination, in order to set the container treatment line for treating the containers.

3. The container treatment line according to claim 1, wherein the coordination device is configured to carry out self-configuration of the at least two container treatment devices on the basis of the comparison result of the comparison device and/or the alignment result of an alignment device.

4. The container treatment line according to claim 1, wherein the first predetermined state is an anomaly and/or error that has occurred during the operation of the external container treatment line.

5. The container treatment line according to claim 1, wherein the first predetermined state is a setup state and/or configuration state that occurred during the commissioning of the external container treatment line.

6. The container treatment line according to claim 1, wherein the first predetermined state is a configuration that has been undertaken for the operation of the external container treatment line.

7. The container treatment line according to claim 1, wherein the determination device is at least one sensor and/or at least one data evaluation unit for determining the actual state of the at least one predetermined element.

8. The container treatment line according to claim 1, wherein the at least one structural property of the predetermined element is the time or year of manufacture of the predetermined element and/or of the at least two container treatment devices.

9. The container treatment line according to claim 1,
wherein the predetermined state stored in the first database is a state of the predetermined element classified as an error, and
wherein the coordination device is configured to create and output a recommended action that is based on the comparison result of the comparison device.

10. The container treatment line according to claim 1, furthermore comprising a display device for displaying at least one output of the determination device and/or the comparison device and/or the coordination device.

11. The container treatment line according to claim 1, furthermore comprising a coupling device for coupling the treatment of the containers with the first container treatment device and the treatment of the containers with the second container treatment device on the basis of data that are stored in the first database.

12. The container treatment line according to claim 11, wherein the coupling device is configured to set at least one parameter for treating the containers, which is to be used in the second container treatment device when treating the containers, to at least one parameter for treating the containers, which is set in the first container treatment device when treating the containers.

13. The container treatment line according to claim 1, wherein the determination device is configured to determine the actual state of the at least one predetermined element, a setting of the predetermined element of the first container treatment device or the second container treatment device.

14. The container treatment line according to claim 13, wherein the setting of the predetermined element of the first container treatment device or the second container treatment device comprises at least one of the following settings: an installation height of the predetermined element, a composition of a liquid or gaseous medium, a temperature of an element or of a liquid or gaseous medium, an exposure time, a torque of the predetermined element.

15. The container treatment line according to claim 1, wherein the at least two container treatment devices comprise at least one blow-molding machine that is configured for blow molding the containers from a preform in each case.

16. The container treatment apparatus according to claim 1, furthermore comprising at least one heating element for emitting heat radiation for heating preforms.

17. The container treatment line according to claim 1, wherein the at least two container treatment devices comprise at least one transport device for transporting the containers in the container treatment line.

18. The container treatment line according to claim 17, wherein the at least one transport device is configured for transporting the containers relative to at least one of the first container treatment device and/or the second container treatment device.

19. A container treatment method for treating containers in a container treatment line which comprises at least two container treatment devices, which comprise at least a first container treatment device for treating the containers and a second container treatment device for treating the containers, and which are configured to exchange data with one another in relation to the treatment of the containers, wherein the method comprises the following steps,
determining, with at least one determination device, an actual state of at least one predetermined element that is intended for treating the containers with at least one of the at least two container treatment devices,
comparing, with a comparison device, the actual state determined by the determination device with a predetermined state stored in a first database, which is a measurement and/or control state in relation to the operation of an external container treatment line, which comprises at least one container treatment device that is at least partially structurally identical to one of the at least two container treatment devices, and
coordinating, with a coordination device, at least one setting for treating the containers to be made in the first container treatment device with at least one setting for treating the containers to be made with the second container treatment device,
wherein the coordination device carries out its coordination on the basis of the comparison result of the comparison device.
